(19) United States
(12) Patent Application Publication
(10) Pub. No.: US 2007/0186183 A1
(43) Pub. Date: Aug. 9, 2007

(54) User interface for presenting a palette of items

(75) Inventor: Thomas R. Hudson JR., Cary, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/347,861

(22) Filed: Feb. 6, 2006

(51) Int. Cl. G06F 3/048

(52) U.S. Cl. 715/810; 715/853

(57) ABSTRACT

The present invention provides a user interface for presenting a palette of items. A method in accordance with an embodiment of the present invention includes: arranging a plurality of items into a plurality of groups, each group including at least two items; and selectively displaying each group in either an expanded state, wherein all of the items in the group are displayed, or in a collapsed state, wherein only a most recently used item of the group is displayed.

### FIELD OF THE INVENTION

The present invention generally relates to user interfaces, and more specifically relates to a user interface for presenting a palette of items.

### BACKGROUND OF THE INVENTION

For large palettes of items, a user interface (UI) often groups the items into hierarchies. This is commonly done using drawers. Such items commonly include, for example, tools, templates, etc. Although drawers are useful in some applications, their user interaction is not ideal. For example, a user must always open a drawer to get to one of the items inside of it. Further, in many cases, only one drawer can be open at any given time. To this extent, the opening of one drawer causes an open drawer to close simultaneously. In those cases where multiple drawers can be opened at the same time, a user cannot access an item inside a drawer without first opening the drawer. Also, a drawer must be given some type of meaningful name which is not always easy to pick and just wastes valuable space in the UI. Further, in applications that would benefit from additional levels of grouping, drawers are not suitable.

In view of the foregoing, there is a need in the art for an improved UI for presenting a palette of items.

### SUMMARY OF THE INVENTION

The present invention provides a user interface (UI) for presenting a palette of items. The invention provides a new grouping mechanism for a UI, which is compact yet flexible to different modes of usage.

A first aspect of the present invention is directed to a method for presenting a palette of items, comprising: arranging a plurality of items into a plurality of groups, each group including at least two items; and selectively displaying each group in either an expanded state, wherein all of the items in the group are displayed, or in a collapsed state, wherein only a most recently used item of the group is displayed.

A second aspect of the present invention is directed to a system for presenting a palette of items, comprising: a system for arranging a plurality of items into a plurality of groups, each group including at least two items; and a system for selectively displaying each group in either an expanded state, wherein all of the items in the group are displayed, or in a collapsed state, wherein only a most recently used item of the group is displayed.

A third aspect of the present invention is directed to a user interface (UI) for presenting a palette of items, comprising: a plurality of groups of items arranged vertically within a defined area, wherein each group includes a plurality of items; each group including a expand/collapse widget for selectively presenting the group in either an expanded state, wherein all of the items in the group are displayed, or in a collapsed state, wherein only a most recently used item of the group is displayed.

A fourth aspect of the present invention is directed to a program product stored on a tangible medium for presenting a pallet of items, the tangible medium comprising program code for performing the steps of: arranging a plurality of items into a plurality of groups, each group including at least two items; and selectively displaying each group in either an expanded state, wherein all of the items in the group are displayed, or in a collapsed state, wherein only a most recently used item of the group is displayed.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a UI for presenting a palette of items in accordance with an embodiment of the present invention.

FIGS. 2-4 depict portions of a UI for presenting a palette of items in accordance with embodiment(s) of the present invention.

FIG. 5 depicts a UI for presenting a palette of items in accordance with an embodiment of the present invention.

FIG. 6 depicts an illustrative computer system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

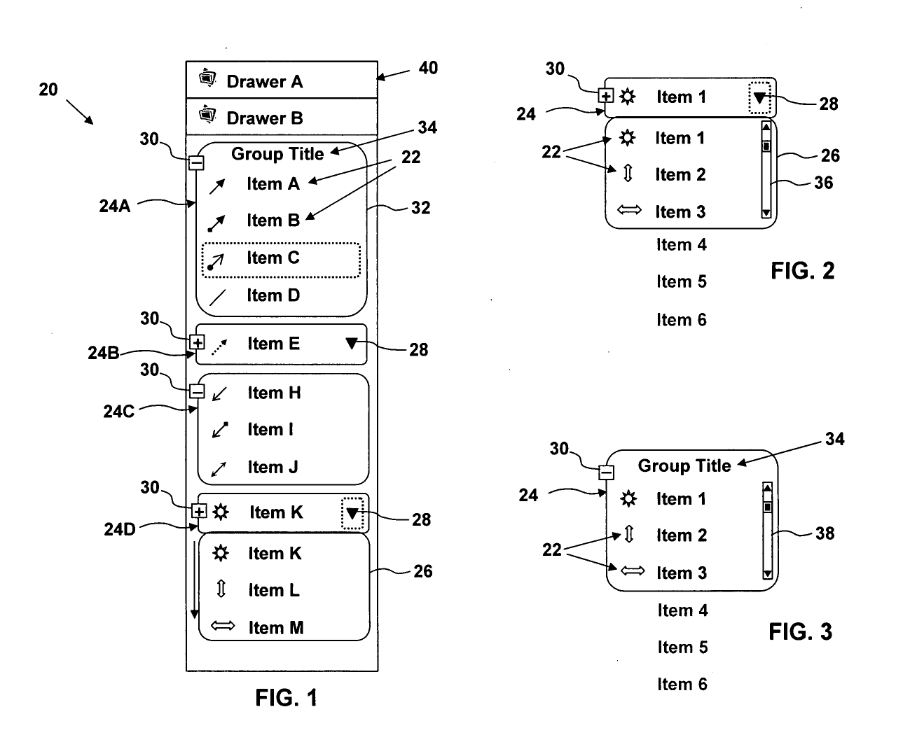

A user interface (UI) 20 for presenting a palette of items 22 in accordance with an embodiment of the present invention is depicted in FIG. 1. The UI 20 displays at least one group 24 (e.g., groups 24A-D) of items 22, wherein each group 24 includes a plurality of items 22. An item 22 can comprise, for example, a tool, a template (e.g., an item that can be dragged from the UI to some other location), a combination tool/template, or other type of item presented in a UI. Each group 24 of items 22 can be delineated using an optional border 32 as shown or in any other suitable manner. The appearance of the border 32 can change due to user actions such as a mouse pointer roll-over, tabbing, etc. A group 24 can also include an optional title 34. The UI 20 has a rectangular configuration, although other configurations are possible. When multiple groups 24 are present in the UI 20, the groups 24 are arranged vertically within the rectangular area defining the UI 20.

The general behavior of a group 24 of items 22 is as follows:
(1) A group 24 can behave in a manner similar to that of a drawer, where the group 24 can be expanded such that all of the items 22 belonging to the group 24 are visible and can be selected by the user. The user can repeatedly select items 22 from within an expanded group 24 with a single mouse click. The user may also collapse an expanded group 24 of items 22. Multiple groups 24 can be expanded at the same time.
(2) When collapsed, a group 24 behaves as a drop-down, wherein the items 22 belonging to a collapsed group 24 can be temporarily presented in a drop-down window 26 by actuating a drop-down widget 28 or other suitable mechanism associated with the collapsed group 24 (or by using a keyboard equivalent). The user can then select one of the items 22 from the collapsed group 24 displayed in the drop-down window 26, without committing to expanding the collapsed group 24. This avoids having to either automatically collapse one or more expanded groups 24 or reduce the amount of space distributed among other expanded groups 24. This interaction requires two mouse clicks (one on the drop-down widget 28 and one on an item 22 in the drop-down window 26 to select an item 22 from a collapsed group 24.
(3) When collapsed, a group 24 displays the most-recently-used (MRU) item 22. This allows one mouse click access to the MRU item 22 in a collapsed group 24. The user thus avoids having to either expand a collapsed group 24 and then select an item 22, or temporarily expand a collapsed group 24 via a drop-down widget 28 and then select an item 22 from the drop-down window 26.

As shown in FIG. 1, regarding item (1) above, the group 24A has been expanded to display the items 22 (Item A, Item B, Item C, and Item D). Similarly, the group 24C has been expanded to display the items 22 (Item H, Item I, and Item J). A user can expand a group 24 by clicking on or otherwise actuating an associated expand/collapse widget 30 or other suitable mechanism. The user can select any of the items 22 within an expanded group 24 using a single mouse click. For example, in FIG. 1, the item 22 (Item C) in the expanded group 24A has been selected by the user.

When a group 24 is in a collapsed state (e.g., groups 24B, 24D), the expand/collapse widget 30 appears as a plus sign (+) and a drop-down widget 28 is displayed. When a group 24 is in an expanded state (e.g., groups 24A, 24C), the expand/collapse widget 30 appears as a minus (−) sign. Using an expand/collapse widget 30, the user can toggle between an expanded and collapsed state of a group 24. Other variations of the expand/collapse widget 30 are also possible. For example, the expand/collapse widget 30 may appear as a “swivel” (e.g., a “▾” or “ [symbol] ”) or as chevrons (e.g., a “>>” or “<<”). Keyboard shortcuts may also be used to expand and collapse a group 24. For example, the “+” and “−” keys can be used to expand or collapse a group 24. Also, the “alt+down_arrow” and “alt+up_arrow” key combinations can be used to pull down and roll up a drop-down window 26 (see below), respectively. The “Enter” key can be used to select an item 22. A group 24 need not be a UI element that receives keyboard focus. Therefore, it may be necessary for keys to be processed at the palette items, which typically can have keyboard focus.

In FIG. 1, the collapsed group 24B includes the items 22 (Item E, Item F, and Item G), where the items 22 (Item F and Item G) are not currently visible to the user. However, the items 22 (Item K, Item L, and Item M) in the collapsed group 24D are temporarily visible to the user in a drop-down window 26 and can be selected by the user.

With regard to item (2) above, the items 22 (Item K, Item L, and Item M) within the collapsed group 24D are displayed in a drop-down window 26 in response to the user actuation of the drop-down widget 28 associated with the collapsed group 24D. In general, a drop-down window 26 is displayed until the user either: selects one of the items 22 displayed in the drop-down window 26; or performs some action which causes the drop-down widget 28 associated with the drop-down window 26 (or the corresponding collapsed group 24) to lose focus. An example would be clicking elsewhere on the screen (e.g., by clicking on an item 22 in another group 24, etc.).

Via the drop-down window 26, the user can then select one of the items 22 (Item K, Item L, and Item M) from the collapsed group 24D, without committing to expanding the collapsed group 24D. This avoids having to either automatically collapse one or more of the expanded groups 24A, 24C or reduce the amount of space distributed among the expanded groups 24A, 24C. This interaction requires two mouse clicks (one on the drop-down widget 28 in the collapsed group 24D and one on an item 22 (Item K, Item L, or Item M) in the drop-down window 26) to select an item 22 from the collapsed group 24D.

As depicted in FIG. 2, scrolling can be provided (e.g., via a scroll-bar 36) when the drop-down window 26 is not large enough to display all of the items 22 in a collapsed group 24. Thus, using the scroll-bar 36, a user can scroll up/down through the drop-down window 26 to view all of the items 22 (e.g., Items 1-6) within the collapsed group 24. Similarly, as shown in FIG. 3, scrolling can be provided (e.g., via a scroll bar 38) when an expanded group 24 is not large enough to display all of its items 32. Thus, using the scroll-bar 38, a user can scroll up/down through the expanded group 24 to view all of the items 22 (e.g., Items 1-6) within the expanded group 24. Other types of scrolling are also possible. For example, scroll buttons can appear at the top and bottom of a drop-down window 26 or expanded group 24, not on the side as shown. Scrolling can then be activated by clicking on a scroll button, hovering over a scroll button, or in any other suitable manner. The up “↑” and down “↓” arrow keys can also be used to control scrolling.

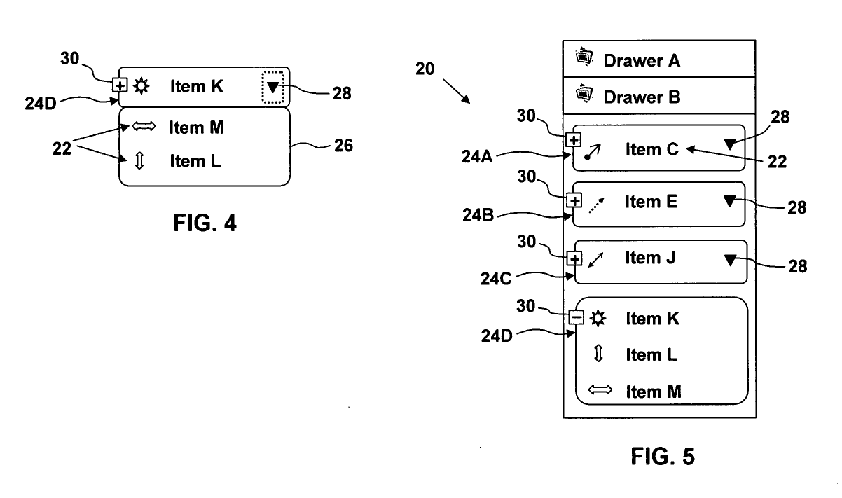

The items 22 displayed in a drop-down window 26 can be reordered to reflect the most recent usage of the items 22 in a collapsed group 24. For example, the previously used item 22 can be the first item 22 displayed in the drop-down window 26. An example of this with regard to the group 24D of FIG. 1 is displayed in FIG. 4. In this example, it is assumed that the item 22 (Item M) was the most recently used item 22 in the collapsed group 24, followed by the item 22 (Item L). As such, the item 22 (Item M) is the first item 22 displayed in the drop-down window 26 and the item 22 (Item L) is the second item 22 displayed in the drop-down window 26. Further, if desired, the currently active item 22 (e.g., Item K) need not be displayed in the drop-down window 26.

Assume, for example, with regard to the UI 20 displayed in FIG. 1, that the user has collapsed the group 24A after selecting the item 22 (Item C), collapsed the group 24C after selecting the item 22 (Item J), and expanded the group 24D by actuating the associated expand/collapse widget 30 for the group 24D. The UI 20 now appears as depicted in FIG. 5. As shown, the most recently used (MRU) item 22 is displayed in each of the collapsed groups 24A and 24C. In particular, the MRU item 22 (Item C) is displayed in the collapsed group 24A, while the MRU item 22 (Item J) is displayed in the collapsed group 24C. This allows one mouse click access to the MRU item 22 in a collapsed group 24 (e.g., the MRU item 22 (Item C) in the collapsed group 24A or the MRU item 22 (Item J) in the collapsed group 24C). The user thus avoids having to either expand a collapsed group 24 and then select the MRU item 22, or temporarily select a collapsed group 24 via a drop-down widget 28 and then select the MRU item 22 from the drop-down window 26.

It can also be seen by comparing FIGS. 1 and 5 that the expand/collapse widget 30 in groups 24A, 24C has changed from a minus sign (−) to a plus sign (+) in response to the collapse of the groups 24A, 24C, while the expand/collapse widget 30 in group 24D has changed to a minus sign (−) in response to the expansion of group 24D. Further, it can be seen that the groups 24A, 24C now include a drop-down widget 28, while the drop-down widget 28 in group 24D has disappeared. The state of the group 24B has not changed between FIGS. 1 and 5.

Although the UI 20 in FIG. 1 is shown as including drawers 40, the present invention can be used in conjunction with drawers or without drawers. Further, the UI 20 can include nested groups (i.e., groups within groups). In this case, a drop-down window used in a collapsed group can contain cascading menus or indentation. Ungrouped items can also exist along side groups.

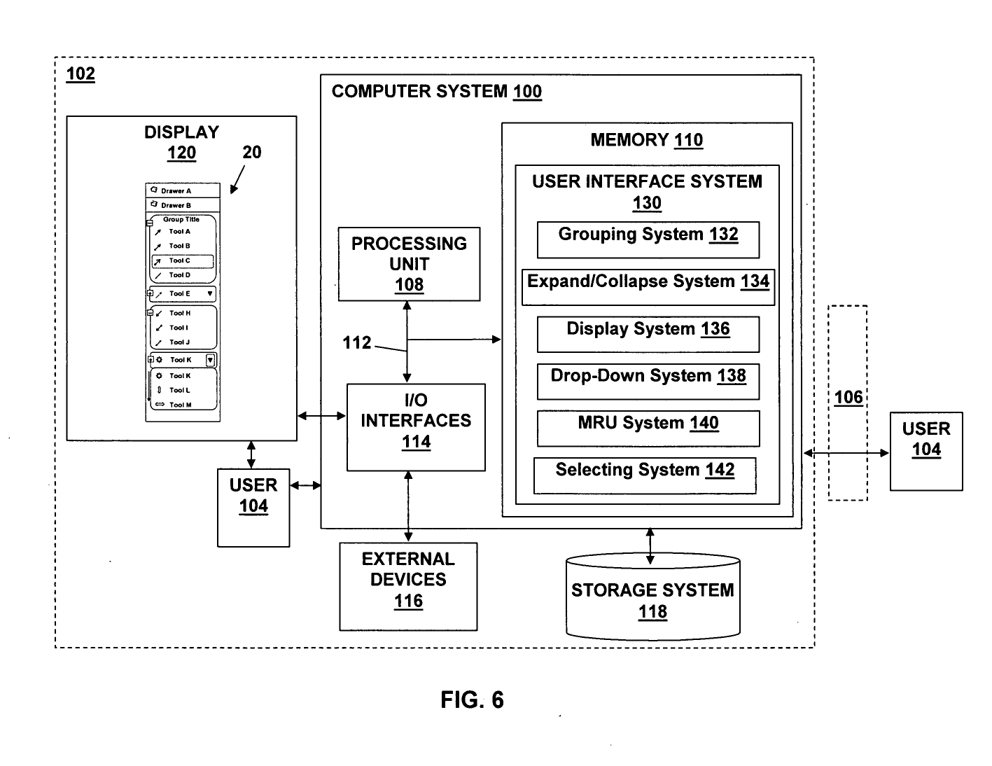

A computer system 100 for providing a UI 20 for presenting a palette of items in accordance with an embodiment of the present invention is depicted in FIG. 6. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides a UI for presenting a palette of items in accordance with the present invention. It should be appreciated that a user 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as user interface system 130, that is stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 1 10 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 6 can be included in computer system 100. However, if computer system 100 comprises a handheld device or the like, it is understood that one or more external devices/resources 116 (e.g., a display) and/or one or more storage system(s) 118 can be contained within computer system 100, and not externally as shown.

Storage system(s) 118 can be any type of system (e.g., a database) capable of providing storage for information under the present invention. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user 104 can contain computerized components similar to those described above with regard to computer system 100.

Shown in memory 110 (e.g., as a computer program product) is a user interface system 130 for providing a UI 20 for presenting a palette of items in accordance with embodiments of the present invention. The user interface system 130 generally includes a grouping system 132 for grouping a plurality of items in different groups, an expanding/collapsing system 134 for expanding/collapsing a group of items in response to the actuation of a corresponding widget, and a display system 136 for displaying the components of the UI 20 (e.g., on display 120). Also provided are a drop-down system 138 for generating a drop-down window for a collapsed group of items in response to the actuation of a corresponding widget, a MRU system 140 for providing one-click access to a most recently used item in a collapsed group, and a selecting system 142 for selecting an item in a group.

The present invention can be offered as a business method on a subscription or fee basis. For example, one or more components of the present invention can be created, maintained, supported, and/or deployed by a service provider that offers the functions described herein for customers. That is, a service provider can be used to provide a service for providing a UI for presenting a palette of items, as described above.

It should also be understood that the present invention can be realized in hardware, software, or a combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or tangible medium providing program code for use by or in connection with a computer or any instruction execution system. For the purposes of this description, a computer-usable or tangible medium can be any apparatus that can contain, store, communicate, or transport the program for use by or in connection with the instruction execution system, apparatus, or device.

The medium can be an electronic, magnetic, optical, electromagnetic, infrared, or semiconductor system (or apparatus or device). Examples of a tangible medium include a semiconductor or solid state memory, magnetic tape, removable computer diskette, random access memory (RAM), read-only memory (ROM), rigid magnetic disk and optical disk. Current examples of optical disks include a compact disk—read only disk (CD-ROM), a compact disk—read/write disk (CD-R/W), and a digital versatile disk (DVD).

Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method for presenting a palette of items, comprising:
arranging a plurality of items into a plurality of groups, each group including at least two items; and
selectively displaying each group in either an expanded state, wherein all of the items in the group are displayed, or in a collapsed state, wherein only a most recently used item of the group is displayed.

2. The method of claim 1, further comprising:
selectively and temporarily displaying all of the items within a group that is in the collapsed state.

3. The method of claim 1, further comprising:
providing each group that is in the collapsed state with a drop-down mechanism; and
temporarily displaying all of the items within the group in response to an actuation of the drop-down mechanism.

4. The method of claim 3, wherein the temporarily displayed items are displayed in a separate window.

5. The method of claim 3, further comprising:
reordering the temporarily displayed items based on recent usage.

6. A system for presenting a palette of items, comprising:
a system for arranging a plurality of items into a plurality of groups, each group including at least two items; and
a system for selectively displaying each group in either an expanded state, wherein all of the items in the group are displayed, or in a collapsed state, wherein only a most recently used item of the group is displayed.

7. The system of claim 6, further comprising:
a system for selecting an item from one of the groups.

8. The system of claim 6, wherein each group includes an expand/collapse mechanism, further comprising:
a system for selectively toggling each group between the expanded state and the collapsed state in response to an actuation of the expand/collapse mechanism.

9. The system of claim 6, further comprising:
a system for selectively and temporarily displaying all of the items within a group that is in the collapsed state.

10. The system of claim 6, wherein each group that is in the collapsed state includes a drop-down mechanism, further comprising:
a system for temporarily displaying all of the items within the group in response to an actuation of the drop-down mechanism.

11. The system of claim 10, wherein the temporarily displayed items are displayed in a separate window.

12. A user interface (UI) for presenting a palette of items, comprising:
a plurality of groups of items arranged vertically within a defined area, wherein each group includes a plurality of items;
each group including a expand/collapse widget for selectively presenting the group in either an expanded state, wherein all of the items in the group are displayed, or in a collapsed state, wherein only a most recently used item of the group is displayed.

13. The UI of claim 12 wherein each group further includes an expand/collapse mechanism, wherein each group can be selectively toggled between the expanded state and the collapsed state in response to an actuation of the expand/collapse mechanism.

14. The UI of claim 12, wherein each group that is in the collapsed state further includes a drop-down mechanism, wherein all of the items in a group that is displayed in the collapsed state can be temporarily displayed in response to an actuation of the drop-down mechanism.

15. The UI of claim 14, wherein the temporarily displayed items are displayed in a separate window.

16. A program product stored on a tangible medium for presenting a pallet of items, the tangible medium comprising program code for performing the steps of:
arranging a plurality of items into a plurality of groups, each group including at least two items; and
selectively displaying each group in either an expanded state, wherein all of the items in the group are displayed, or in a collapsed state, wherein only a most recently used item of the group is displayed.

17. The program product of claim 16, further comprising program code for performing the step of:
selecting an item from one of the groups.

18. The program product of claim 16, wherein the item comprises a tool, a template, or a combination thereof.

19. The program product of claim 16, further comprising program code for performing the steps of:
providing each group with an expand/collapse mechanism; and
selectively toggling each group between the expanded state and the collapsed state in response to an actuation of the expand/collapse mechanism.

20. The program product of claim 16, further comprising program code for performing the step of:
arranging the groups vertically within a defined area.
